(19) United States
(12) Patent Application Publication
(10) Pub. No.: US 2004/0262585 A1
(43) Pub. Date: Dec. 30, 2004

(54) Use of dendrimers and poly-branched molecules to enhance signal in fluorescent assay systems

(76) Inventors: William J. Cummins, Hertfordshire (GB); Alan L. Hamilton, Buckinghamshire (GB); Mark Bradley, Hampshire (GB); John Ellard, Bedfordshire (GB); Thomas Zollitsch, Regensburg (DE); Mark Samuel Jonathan Briggs, Cardiff (GB)

Correspondence Address: AMERSHAM BIOSCIENCES, PATENT DEPARTMENT, 800 CENTENNIAL AVENUE, PISCATAWAY, NJ, 08855, US

(21) Appl. No.: 10/485,726

(22) PCT Filed: Jul. 31, 2002
(86) PCT No.: PCT/GB02/03517

(51) Int. Cl. G03C 1/00

(52) U.S. Cl. 252/582

(57) ABSTRACT

A novel form of dendrimer, polybranched molecule, is described in which fluorescent dyes of the structure exist in a micro environment that affects their fluorescent properties. Within the dendrimer, poly-branched molecules are cleavage sites. When these cleavage sites are treated with a suitable chemical or enzyme which cleaves selective bonds the dyes of the structure are released and a change in their optical properties is effected, notably an increase in fluorescent signal. Methods of using the dendrimer, poly-branched molecule in assays of biological molecules are also described.

### FIELD OF INVENTION

This invention relates to a class of compounds called dendrimers and poly-branched molecules, which are useful in the detection of biological molecules using fluorescent assays and other test procedures.

### BACKGROUND TO THE INVENTION

Dendrimers are a class of macromolecules possessing a well-defined structure and molecular composition. They are created by the stepwise attachment of monomer units in repeating unit layers, termed generations, that creates branches built upon a central core. These branches frequently terminate in a specific chemical functional group that can be used for further modification or attachment of specific compounds as required. The outer surface of the dendrimer can be affected by the number of generations involved in producing it, and by altering the monomer unit or units that make-up the branches.

The use of macro dendritic or polymer type structures as an amplification system has been reported. Thus hybridization properties of nucleic acid oligonucleotides (oligos) have been utilised to build up a complex, three dimensional dendritic structure. Some or all of the oligos involved in the hybridization to the scaffold are labelled with a fluorescent dye, radioactively, or with a hapten for an indirect detection end point resulting in signal amplification. Specific fluorescent amplification has also been achieved by incorporation of polymers specifically designed for water solubility, covalent attachment to biomolecules and fluorescent enhancement. (Pitsehbe et al Colloid and Polymer Science (1995) 273, 740).

A drawback to the above approaches is that the resulting polymer or dendrimer is a significant molecule in terms of both mass and the three-dimensional space it occupies. Thus, it is not always appropriate for use in signal amplification in a biological application currently using a fluorescent detection end point, such as sequencing, microarrays, both single and two dimensional gel protein analysis, in vitro and in vivo assay type system.

Fluorescence has become the detection modality of choice in many biological application areas. The current fluorescent dyes used in the applications are all characterised by having a functional group (FG) for attachment to a biological molecule, a linker arm from the FG to the chromophore and frequently solubilising group or groups, such as SO⁻₃ attached to or incorporated on the chromophore to aid water solubility. Reaction of the functional group with the biomolecule being investigated results in the attachment of a single dye. The range of such singularly functionalised dyes is quite extensive see for example U.S. Pat. No. 5,627,027, U.S. Pat. No. 6,140,494, WO 97/06090 and WO 99/15517. Increased signal is only available by multiple attachment of these singularly functionalised dyes. Where there is a limited number of suitable attachment points to a biological molecule, alternative means of increasing sensitivity are still required.

The use of macro dendrimer structures as an amplification system has already been highlighted. Where it is desirable for more discrete, well characterised dendrimers or poly-branched molecules to be utilised, standard organic chemistry methodology can be employed. The dendrimers or poly-branched molecules synthesised can be modified for attachment to biomolecules that can be targeted to particular anatomical or physiological sites. By attachment of pharmacologically or therapeutically active moieties at the dendrimer branches' termini, an enhanced therapeutic dose could be delivered in in-vivo situations. Thus antibodies labeled with dye loaded dendritic peptide structures have been considered as a means of delivering a greater load of photoactive molecules via a single protein targeting vehicle (Giovannovi et al J Peptide Res (2000), 55, 195-202). In this paper results show that there is a proportional increase in fluorescent signal with respect to dye loading. There is no indication that self quenching of fluors is observed in this system or that an increase in fluorescent signal is achieved by releasing fluors from the structure. Indeed, it would be a detriment to their application aim as it is aimed at high concentration of photoactive molecules in one position. In a diagnostic situation, dendrimers whose branches terminate with spin signals have been considered for enhancement of a magnetic resonance image (Keana et al U.S. Pat. No. 5,567,411).

The use of dendrimers or poly-branched molecules to aid amplification of a fluorescent signal has not always been successful as they can suffer from the inherent self-quenching of a number of dyes in close proximity. This drawback has been noted and an approach via a rigid central scaffold to point the dyes away from each other has been tried (Martin et al, Tet. Letts., (1999), 40, 223-226, Martin et al, WO 99/49831).

### SUMMARY OF THE INVENTION

The present invention provides discrete, well characterised compounds based on dendrimers or poly-branched molecules for attachment to biomolecules or solid surfaces, containing at least two branches and a single cleavage site in each branch linked to a fluorescent dye. The dye is located on the fragment of the compound which is released from the dendrimer or poly branched molecule upon cleavage, preferably at the terminus of the branch. The structure of the dendrimer or poly-branched molecule is such that the fluorescent dyes are contained within a microenvironment which affects their properties while attached to the dendrimer or poly-branched molecule. Upon cleavage of the fluorescent dyes or a fragment containing a fluorescent dye from the dendrimer or poly-branched molecule or conjugate with a biomolecule or solid surface, the optical properties of the dye are changed and that change of optical property can be detected and is enhanced due to the number of dyes released. In a preferred embodiment the change of optical property is represented by the restoration of fluorescence from a dye that had been quenched with an overall effect of increasing the fluorescent signal.

In one aspect of the present invention the dendrimer-dye molecule or poly-branched molecule linked dye has within the structure at least one cleavable linkage such that when the linkage is cleaved a change in an optical property of the dye occurs. The terms dendrimer-dye molecule or poly-branched molecule linked dye as used herein are characterized by having a dendrimer or poly-branched molecule containing a dye. The term poly-branched molecule as used herein includes a molecule where only one addition of monomer units has taken place on each branch.

In a second aspect, the invention provides compounds of the formula below:—

(PG¹)-(FG¹)-L¹-C-[(L²)ₓ-(((CP)-L³-(FG²)-D)_{y} (-L³ X)ₙ)]ₘ

Wherein PG is an optional protecting group for FG¹. FG¹ is a reactive chemical functional group that allows for chemical reaction with surfaces, biomolecules or dyes as appropriate. FG² can be the same or different as FG¹ and allows for reaction with a reactive dye. L¹ is a linker group connecting the functional group to the core branching point C. L² is a linker made from successive reactions of the same or different monomer units to generate the generations on the dendrimer and may itself contain branching points. The number x represents the number of generations of monomer units that have been added and has a minimum value of 1, suitably 1 to 12 and preferably 1 to 6. CP is a chemical or enzymatic cleavage point which can be the same or different in different branches. L³ is a linker group to a functional group FG², which is capable of being linked to a fluorescent dye molecule D. The fluorescent dye molecules can be the same or different. There must be at least two initial branch points from the core dendrimer branching point C, thus m must be at least 2, suitably 2 to 8 and preferably 2 to 4. The value of y is dependant upon any branching that occurs in the addition of the monomer units that make up L². The value of y can be large i.e. up to 64 but preferably within the range of 2 to 32 and more preferably within the range of 2 to 12. In the simplest case y=m and must be a minimum of 2. It is not a requirement that every branch terminates in a dye. Where a branch does not terminate with a dye, then a group X is present where X can assist in the overall properties of the dendrimer or represent a capping group. The value of n is a minimum of zero and has a maximum of y-2.

### DESCRIPTION OF DRAWINGS

FIG. 1 shows the fluorescent spectrum of dendrimers and poly-branched conjugates in pH 9 solution initially (FIG. 1a) and after 7 days (FIG. 1b) Y axis fluorescence units, X-axis wavelength

FIG. 2 shows the increase in fluorescence against time when dendrimers are incubated with chymotrypsin.

FIG. 3 shows the effect of Endoproteinase Asp-N cleavage on a dendrimer with increasing time

### DESCRIPTION OF THE INVENTION

The present invention provides for discrete, well-characterized dendrimer compounds or poly-branched molecules for attachment to biomolecules and containing branches terminating in a cleavage site linked to a fluorescent dye. The structure of the dendrimer or poly-branched molecule is such that the fluorescent dyes are self quenched while attached to the dendrimer or poly-branched molecule. The invention provides a dendrimer-dye molecule or poly-branched molecule linked dye characterized by having within the structure at least one cleavable linkage which when cleaved permits the formation of a change in optical properties of the dye. In a preferred embodiment the change in optical properties is an increased fluorescent signal. The increase in fluorescent signal should be at least 1.2 fold, preferably at least 1.5 fold and more preferably at least 2 fold. Results in the experimental section show and enhancement of fluorescent signal of at least 5 to 6 fold. The exact number will be dependent on the original number of dyes present.

A further embodiment of the present invention provides for discrete, well characterised dendrimer dye compounds or poly-branched molecule linked-dye for attachment to biomolecules and containing branches terminating in a cleavage site linked to a fluorescent dye. The dendrimer-dye, poly-branched molecule linked-dye structure is such that it effectively places the dye in a microenvironment that effects the optical properties of the dyes. This can be via quenching as already described or by other changes such as in the lipophilicity or hydrophilicity of the microenvironment. Thus dyes such as Nile Red will undergo changes in optical properties depending upon the polarity of its environment, (Sackett and Wolff, Analytical Biochemistry 167 228-234 (1987). The changes in solvation spheres of dyes has also been observed to change optical properties of dyes (Zollinger in Colour Chemistry, Synthesis, Properties and Applications of Organic Dyes and Pigments, Second revised Ed, publishers VCH.) Dyes have also been observed to change optical properties due to the folding of proteins (Nakanishi et al, Analytical Chemistry pages A-I (2001)).

The optical properties of dyes include its ability to fluoresce, the lifetime of fluorescence, and the absorption spectra and emission spectra of that fluorescence. In particular it is well known that quenching of fluorescence leads to change in the lifetime of the fluorescence decay of the fluor under observation (Bernard Valeur, ‘Effects of intermolecular photophysical processes on fluorescence emission’ in ‘Molecular Fluorescence’, 2002, Chapter 4.1, Wiley-VCH, Weinheim; Joseph Lakowicz, ‘Energy Transfer’ in Principles of Fluorescence Spectroscopy, 2nd ed., 1999, Chapter 13.1.C, Kluwer Academic, New York). As such, it is possible to quantitate and discriminate between the fluorescence signals originating from different species with the same emission wavelength but with distinct fluorescence lifetimes. This may be used to reduce background signals, thus improving signal to noise ratios and data fidelity, by selecting for fluorescence emission which originated only from free, unquenched fluors. In addition it may also be possible to selectively quantitate the signals originating from the free and quenched fluorophore populations on the basis of combined fluorescence lifetime and intensity measurements thus enabling the relative ration of the two to be determined.

Where the dendrimer-dye molecule or poly-branched molecule linked-dye is attached to a biomolecule being used in a cellular assay, the point at which the optical properties of the attached dye is changed due to cleavage from the dendrimer-dye molecule or poly-branched molecule linked-dye infers both the event of cleavage and a specific point of cleavage in the cell. Manipulation of the cleavage site to a specific expression of an enzyme, e.g. capases, would allow the study of specific biological mechanisms within the cell. Additionally, a change in the microenvironment surrounding the labelled dendrimer may be utilised to initiate cleavage, a technique often used to control drug delivery and availability. For example, cellular uptake of crosslinked PEI-DNA leading to exposure of the complex to the strongly reducing environment of a cell lead to the reductive cleavage of disulphide crosslinking groups leading to release of DNA for nuclear uptake and transcription. (M. A. Gosselin et al., Bionconjugate Chemistry, 2001, 12(6), 989) Similarly, an increase in fluorescence emission intensity was observed upon the exposure of a fluorophore linked to a quenching moiety via a disulphide bond upon exposure to a mild chemical reductant in vitro, analogous to the reducing environment of a cell, L. Josephson et al., Bioconjugate Chemistry 2002 13(3) 554.

Similarly, changes in pH can also cause cleavage of covalent bonds leading to release of drugs or similar therapeutic reagents from carriers or species which attentuate the efficiacy of the reagent of interest and so has also been utilised within the development of drug delivery systems, S. Lee, Bioconjugate Chemistry, 2001 12(2) 163.

In the preferred embodiment, where the change in optical properties is an increased fluorescent signal upon cleavage of the fluorescent dyes or a fragment containing the dye from the dendrimer-dye molecule or poly-branched molecule linked-dye the fluorescent properties of the dye are restored, i.e. no longer quenched and as a result the fluorescent signal is enhanced relative to the original background fluorescent level. As this background level can be below that of the fluorescence of a single dye and the fluorescence output greater than a single dye, there is a relative enhancement compared to a system where only a single fluorescent dye would have been present.

The approach could have application in either in vitro or in vivo use e.g for the latter tumor visualisation where the cleavage point is linked to a specific enzymatic signature of tumor protein expression.

The use of a cleavage type approach to generate fluorescence is well-known in fluorescent energy transfer (FRET) based assay systems. They are characterized in having within the substrate the following, quencher dye-cleavage site-fluorescent dye. There is a requirement for spectral overlap between the quencher dye and the fluorescent dye such that the fluorescence from the latter is initially internally quenched. When the fluorescent dye is cleaved away from the quencher dye its fluorescent properties are restored and a signal is generated in the assay. FRET systems in which a peptide sequence containing both a fluorophore and an internal quencher are among the best methods for protease analysis and detection. Numerous proteases have been studied using this method including trypsin (S. Grahn et al, Anal Biochem., (1998) 265, 225), cathepsin B (E. Del Nery et al, J Protein Chem. (2000) 19, 33), leukotriene D₄ hydrolase (I. White et al, Anal Biochem., (1999) 268, 245) and caspases 1 and 3 (N. P. Mahajan Chem & Biol (1999) 6, 401)

The dendrimer-dye molecule or poly-branched molecule linked-dye compounds of the invention have distinct advantages over the above FRET based systems in that there is no longer a requirement to have a quencher dye whose properties need to be optimized. Therefore the molecules of the invention do not require a quenching agent of a different molecular species to the fluorescent molecule. This is by virtue of the fluorescent self-quenching of the dyes attached to the termini of the dendrimer-dye molecule or poly-branched molecule linked-dye, previously seen as a disadvantage in the use of fluorescent dendrimers (Martin et al, WO 99/49831). The cleavage of the fluorescent dyes via either chemical or enzymatic means results in the release of a number of fluorescent dyes or fragments containing a dye that imparts a signal enhancement over the original background level. The potential is for an enhanced signal relative to a FRET system based on a single acceptor dye as described above.

The compounds of the invention are defined by

(PG¹)-(FG¹)-L¹-C-[(L²)ₓ-(((CP)-L³-(FG²)-D)_{y}(-L³X)ₙ)]ₘ

The core molecule C of the invention must have at least two sites from which chemical growth can be initiated in the construction of the branches within the dendrimer-dye molecule or poly-branched molecule linked-dye. The core molecule C should be chemically inert to the synthetic protocols required for the synthesis of the dendrimer-dye molecule or poly-branched molecule linked-dye. The core molecule branching point can be formed by a single atom such as carbon, nitrogen, phosphorus or silicon or by a ring such as a five-, six-or seven-membered aliphatic, or aromatic or heterocyclic ring (both aliphatic or aromatic) as appropriate. Examples of possible core molecules C are depicted below complete with the initial functional group sites for the growth of branches.

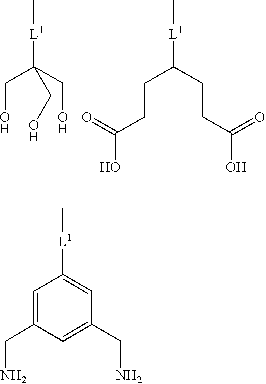

A schematic diagram of a three branched species of the invention is given below. This represents one possible structural representation and is termed a dendrimer-dye molecule or a poly-branched molecule linked dye.

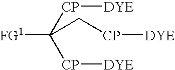

When the dendrimer-dye molecule or a poly-branched molecule linked dye has been reacted with a biomolecule or solid support the resulting product is referred to as a conjugate of that substrate.

The core molecule in addition to the branching sites must have a functional group FG¹ for attachment to a biological molecule, solid surface or other molecules as required. The FG¹ could be nucleophilic in nature, the preferred options being —OH, —SH, —NH₂, —O—NH₂, C(O)NH—NH₂, —NH—NH₂ or could be electrophilic in nature, the preferred options being aldehydes, maleimides, isocyanates, carboxylic acids and their related activated carboxylic species; anhydrides, acid chlorides and active esters. Alternatively the attachment to a biological molecule, solid surface or other molecule may be via a covalent means eg Diels-Alder reaction or a borate ester reaction or by non-covalent means e.g. affinity including biotin, his-tag and others well known to those skilled in the art in which case FG¹ is first modified with the affinity binding portion. The functional group FG¹ is linked to the core molecule via a linker L¹ as required.

L¹ is a linker of 0-60 atoms, preferably 0-30 atoms, which can be branched or unbranched and can optionally contain one or more arylene groups, or O or N or S or P atoms or charged species such as N⁺, S⁺ or P⁺.

The group PG¹ is an optional protecting group for FG¹, for example an OH group can be protected via an acetate, silyl or trityl group or an NH₂ protected by carbamates, amides such as trifluoroacetamide, see T. W. Green and P. G. M. Wuts, Protective Groups in Organic Synthesis, Pub. Wiley-Interscience, (3^{rd} edition 1999) for a review of such protecting groups, or can be a solid surface. The latter can aid in both the synthesis of the dendrimer-dye molecule or poly-branched molecule linked-dye and any subsequent assay system. It is a preferred synthetic approach to build the dendrimer-dye molecule or poly-branched molecule linked-dye assembly while it is attached to a solid support.

The branches of the dendrimer or poly-branched molecule, L², determine the overall structural features of the assembly. The branches can be built by stepwise addition of monomer units from the initial branching site contained within the core molecule. These monomer units can themselves be non-branching or branching or provide by multiple addition to a chemically reactive functional group a further branch point within the overall dendrimer structure. The monomer units making up L² are characterized in that they have a reactive group to facilitate attachment to the growing dendrimer or poly-branched molecule assembly and terminate in a chemically reactive functional group, FG², which would normally be protected by a protecting group, PG², to aid the synthesis of the assembly. The linkers L² impart important features to the overall dendrimer structure such as length, flexibility, and extent of branching, chemical functionality and solubility. The use of solid phase in the synthesis of the dendrimers has advantages over solution phase chemistry in allowing reactions to be driven to completion and ease of purification. A dendrimer or poly-branched molecule in itself has advantages over a linear structure in the number of synthetic steps that are needed to build up a multifunctional species and the overall shape generated for the self quenching of the dyes. A variety of different monomer linkers can be employed to build up a dendritic structure. Thus amino acid monomers (C. Grandjean et al. Tet. Lett., (1999), 40, 7235) to phosphoramidities (WO 99/10362) have both been employed.

The monomer units that make up L² can be added sequentially to the dendrimer to build up the branches of the dendrimer. These can consist of molecules such lysine, acrylic acid, acrylonitrile followed by hydrolysis or aminolysis with diamines or compounds such as the following.

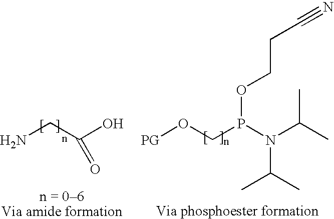

By the selective use of orthogonal protecting groups on different monomers terminal functional groups (FG) it is possible to add different monomer units at selective sites within the growing dendritic assembly to affect the overall shape of the assembly and density of loading with fluorescent dyes. Some of the branches generated by the addition of the monomer units could also be capped with moieties such as X to enhance particular properties of the assembly e.g. charged groups or hydrogen bonding donors and acceptors to help partially rigidise the assembly or sulphonate or phosphate groups to enhance water solubility. This synthetic strategy is greatly aided by starting with a core molecule C that has one or more of its functional groups for branch assembly orthogonally protected to allow for selective monomer addition.

At least two of the dendrimer-dye molecule or poly-branched molecule linked-dye branches are capped with —{((CP)-L³-(FG²)-D)} which results in modification of the optical properties of the dye. The group CP represents a cleavage point. This might be via chemical cleavage such as hydrolysis of an ester or amide, disulphide cleavage with a thiol, acid or base mediated cleavage of specific groups such as ketals or esters, reductive cleavage of esters, hydrogenenation of benzyl based urethanes, oxidative cleavage of benzyl ethers, fluoride cleavage of a silyl linkage, light cleavage of benzoins or nitro-benzyl alcohols or an enzyme cleavage point such as esterases, proteases or nucleases. In the latter the cleavage point CP is within a short piece of a DNA oligo incorporated into the dendrimer-dye molecule or poly-branched molecule linked-dye. The analyte being studied would be a piece of DNA that hybridises to the oligo portion of the dendrimer-dye molecule or poly-branched molecule linked-dye to form a double stranded piece of DNA. This could then be cleavage with a suitable restriction enzyme. An alternative would be that a specific mis-match site is cleavage by an enzyme. This could give rise to the quantification of the amount of a mutant in a given sample of DNA by measuring the fluorescence released. For chemical cleavage a suitably prepared monomer containing the cleavage site needs to be prepared and added to the growing dendrimer at the appropriate stage in its assembly. In the case of a protease cleavage site peptide synthetic methodology can be employed to construct the required site. In the case of a short piece of oligo standard solid phase oligo synthesis could be undertaken or preformed oligo nucleotides appended.

L³ can be the same as L¹ or different and represents a linking group between the cleavage point and the functional group FG² required for the attachment of a dye. FG² can be the same or different to FG¹ and chosen from the same range of chemical functionality as FG¹.

The dye D attached to FG² must be fluorescent and can be chosen from the wide variety of dyes classes now available to label biomolecules including but not limited to cyanines, fluoresceins, rhodamines and BODIPY dyes. In any one particular compound of the invention the dye D can be the same or different. The preferred option is that the same dye is used.

The dendrimer dye molecules or poly-branched molecules linked dyes of the present invention can be used in methods of investigating the properties of a biological molecule of interest. The biological molecule can be one known to those skilled in the art which can be detected or whose mode of action can be detected by fluorescence and include but not limited to protein or peptide eg antibody or fragment, nucleic acid such DNA, RNA or analogues, oligo- or poly-saccharides and receptors or molecules targetting receptors. Such methods form another aspect of the invention and comprise the steps of

a) performing a reaction containing the biological molecule of interest at least some of which has been labelled with a dendrimer-dye molecule or poly-branched molecule linked dye

b) treating the product of step a) if necessary with an agent capable of cleaving the cleavable linkage

c) measuring the change in optical property.

In many assay formats the procedure of step a) will result in the cleavage of the cleavable linkage attached to the dye. One example of this assay format is a protease assay.

The change in optical property is preferably an increase in fluorescence. The increase in fluorescent signal should be at least 1.2 fold, preferably at least 1.5 fold and most preferably at least 2 fold. Results in the experimental section show and enhancement of fluorescent signal of at least 5 to 6 fold.

The invention is illustrated by way of the following examples.

Example 1 Dendrimer synthesis

Example 2 cleavage of an amide bond via base hydrolysis

Example 3 and 4 Dendrimer synthesis and cleavage of a peptide bond by enzymatic means

Abbreviations

| | |
|---|---|
| DCM | Dichloromethane |
| DIC | Diisopropyldicarbodiimide |
| DIPEA | Diisopropylethylamine |
| DMF | Dimethylformamide |
| ES | Electrospray |
| Et₂O | Diethyl ether |
| HEPES | 4-(2-Hydroxyethyl)-1-piperazineethanesulfonic acid |
| HOBt | 1-Hydroxybenzyltriazole |
| HPLC | High Pressure Liquid Chromatography |
| MALDI | Matrix Assisted Laser Desorption Ionistation |
| MeCN | Acetonitrile |
| MeOH | Methanol |
| MS | Mass spectrometry |
| TFA | Trifluoroacetic acid |
| TIS | Triisopropylsilane |
| TOF | Time of flight |

### EXAMPLE 1

### Dendrimer Synthesis

Synthesis of ‘PAMAM’ Dendrimer

Tentagel Chloride Resin (1)

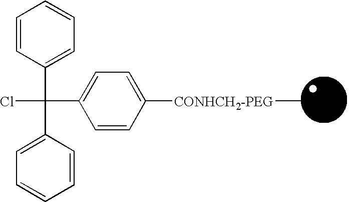

Nova syn TGT alcohol resin (2.0 g, 0.44 mmol, loading: 0.22 mmol/g) was washed with DMF (2×), dry DCM (3×) and dry toluene (3×). The resin was transferred to a round bottomed flask. To the resin (covered in toluene) was added acetylchloride (2 ml) and the reaction heated at 65° C. for 3 hours. The mixture was then slurried to a sintered peptide vessel and the resin washed with dry toluene (3×) and dry DCM (3×).

Tentagel 1,4-diaminobutane resin (2)

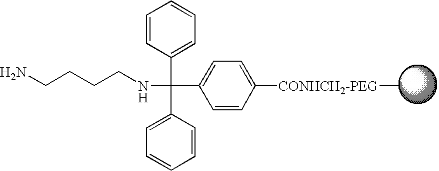

A solution of 1,4-diaminobutane (8.81 ml, 88 mmol) in DCM (20 ml) was added to tentagel chloride resin 1 (2.0 g, theor. loading 0.22 mmol/g) and mixed with a mechanical stirrer for 4 hours. The resin was washed with DCM/DIPEA (v/v 19:1) (3×), DCM (3×) and dried in vacuo.

Fmoc test: 0.19 mmol/g

Ninhydrin test: 0.15 mmol/g

Tentagel Gen. [0.5] PAMAM Dendrimer (3)

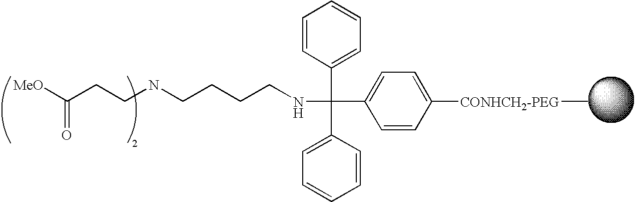

1,4-diaminobutane resin 2 (2.0 g, 0.15-0.19 mmol/g) was swollen in DCM. A solution of methyl acrylate (8.56 ml, 95 mmol) in methanol (10 ml) was added and the mixture shaken at 55° C. for 16 hours. The resin was washed with methanol (3×) and DCM (3×).

IR: 1735 cm⁻1

Tentagel Gen. [1.0] PAMAM Dendrimer (4)

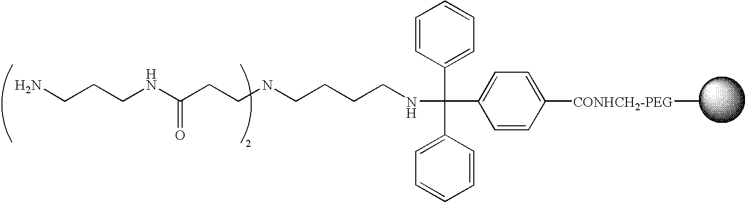

Resin 3 (1.0 g) was swollen in DCM. A solution of 1,3-diaminopropane (19.8 ml, 119 mmol) in methanol (20 ml) was added and the mixture shaken for 72 hours. The resin was washed with methanol (3×), DMF (3×) and DCM (3×) and dried in vacuo.

Loading (NH₂): Fmoc test: 0.27-0.31 mmol/g; Ninhydrin test: 0.27 mmol/g

Synthesis of Tris Dendrimer

3-{2-amino-3-(2-cyanoethoxy)-2-[(2-cyanoethoxy)methyl]propoxy}propanenitrile (5)

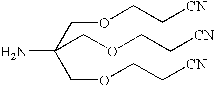

To a stirred solution of acrylonitrile (60 ml, 0.91 mol), aq. KOH (40%, 2 ml) in dioxane (40 ml) was added 2-Amino-2-(hydroxymethyl)-1,3-propanediol (24.24 g, 0.20 mol). The mixture was stirred at RT for 63 hours, then poured into water and acidified with conc. HCl (300 ml). After filtration to remove the precipitate the filtrate was extracted with DCM (3×100 ml), made basic (to pH 11) with conc. aq. NaOH and extracted again with DCM (4×100 ml). The combined organic extracts were washed with water and dried over MgSO₄. Basic Al₂O₃ was then added and the mixture stirred for 6 hours. The alumina was then removed by filtration and the solvent was removed in vacuo to afford 5 (25.0 g, 45%).

Methyl 3-(2-amino-3-[2-(methoxycarbonyl)ethoxy]-2-{[2-(methoxycarbonyl) ethoxy]methyl}propoxy)propanoate (6)

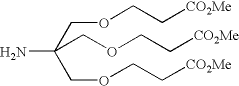

A solution of 5 (22.4 g, 80 mol) in methanol (150 ml) at −50° C. was saturated with gaseous HCl (approx. 30 mins). The stirred solution was maintained at −50° C. for 1 hour then warmed to room temperature before being stirred under reflux for 3 hours. The mixture was stirred overnight at room temperature, filtered and the solvent removed in vacuo. The yellow-brown oil obtained was dissolved in DCM and saturated aq. NaHCO₃ was added. The aqueous phase was dried over Na₂SO₄ and concentrated in vacuo to afford 6 (10.9 g, 36%) as an orange oil.

Dimethyl 6-isocyanato-6-(4-carbomethoxy-2-oxabutyl)4,8-dioxaundecanedioate (7)

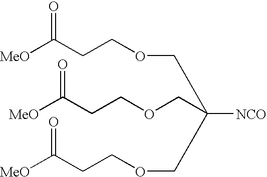

To a stirred solution of dimethyl 6-amino-6-(4-carbomethoxy-2-oxabutyl)-4,8-dioxaundecanedioate 6 (3.79 g, 10 mmol) and dimethylaminopyridine (1.22 g, 10 mmol) in DCM (40 ml) was added a solution of (BOC)₂O (3.06 g, 14 mmol) in DCM (50 ml) and the resulting solution stirred for 2 hours. The solution was washed with 1M aqueous HCl (2×40 ml) and water (2×10 ml). The organic phase was dried over Na₂SO₄ and the solvent removed in vacuo to afford 7 (4.04 g, 99%) as a colourless oil which was used without further purification.

IR (cm⁻1); 2953, 2874, 2245, 1735

¹H (300 MHz, CDCl₃) δ: 3.70 (6H, t, J 6.1, CH₂CH₂CO₂), 3.67 (9H, s, OCH₃), 3.43 (6H, s, CH₂O), 2.55 (6H, t, J 6.4, CH₂CO₂)

¹³C (75 MHz, CDCl₃) δ: 172.0, 127.4, 71.3, 67.1, 63.9, 51.8, 34.9

Resin Bound Gen. [0.5] Tris Dendrimer (8)

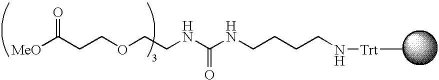

1,4-diaminobutane trityl PS resin (1.0 g, 0.33 mmol, loading: 0.33 mmol/g) was swollen in DMF. A solution of isocyanate 7 (0.2 g, 0.5 mmol) and DMAP (cat.) in DMF (10 ml) was added and the resin spun on the wheel for 2 days. The resin was washed with DMF (3×), MeOH (3×), DCM (3×) and Et₂O (3×) and dried in vacuo. The reaction was repeated twice until a satisfactory ninhydrin test was performed.

IR (cm⁻¹): 1733

Resin Bound Gen. [1.0] Tris Dendrimer (9)

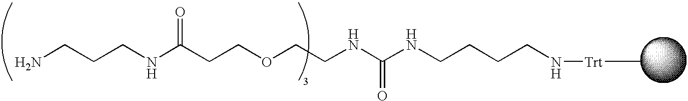

The resin 8 (1.0 g) was swollen in DCM. A solution of 1,3-diaminopropane (20.65 ml, 247.5 mmol) in methanol (20 ml) was added and shaken at 50° C. for 2 days. The resin was then washed with methanol (3×). The reaction was repeated once. The resin was washed with methanol (3×), DMF (3×), and DCM (3×) and then dried in vacuo.

Coupling a small amount of resin with fluorescein isothiocycanate gave a satisfactory HPLC.

Synthesis of TentaGel Trityl Resin Bound Gen. [0.75] Hybrid Dendrimer (10)

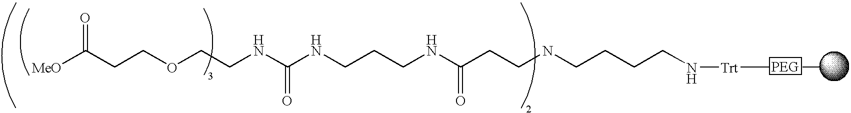

1.0 g of resin 4 (loading (NH₂): 0.27 mmol) was swollen in DMF. Then a solution of isocyanate 7 (405 mg, 1 mmol) in 10 mL DMF was added and shaken for 50 h. The resin was washed with DMF, MeOH, CH₂Cl₂ and ether and dried in vacuo. Ninhydrin test: negative

IR [cm⁻¹]: 1730 (s) (COOMe)

Synthesis of TentaGel Trityl Resin Bound Gen. [1.0] Hybrid Dendrimer (11)

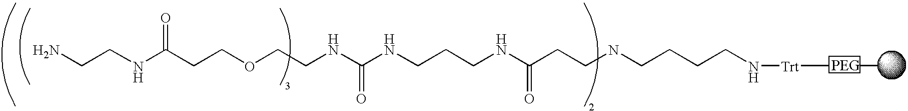

To 1 g of resin 10 (theor. loading: 0.17 mmol/g) a solution of 17.0 ml (250 mmol) 1,2-diaminoethane in 15 mL methanol was added and shaken for 96 h. After the resin was washed with a solution of DIPEA (0.5%) in DMF, DMF and MeOH the reaction was repeated (22 h). The resin was washed with methanol (3×), DMF (3×) and CH₂ Cl₂ (3×) and dried in vacuo.

IR [cm⁻¹]: no ester bond

### EXAMPLE 2

### Chemical Cleavage of Dendrimer

General Procedure for Synthesis of Fluorescein Labelled Dendrimers.

The dendrimer resin was preswolled in DCM. To the preswollen resin was added a solution of fluorescein isothiocyanate isomer I (2 eq) and triethylamine (2 eq) in DMF and the reaction mixture spun on the wheel overnight. The resin was then washed with DMF×3, DCM×3, MeOH×3 and Et₂O×3 and swollen in DCM. To the resin was added 50% TFA, 3% TIS in DCM and the mixture stood for 3 hours. The solution was then drained, the resin was washed with DCM and MeOH and the solvent removed in vacuo. The compounds were then purified by semiprep. HPLC.

Fluorescein Labeled 1,4-diaminobutane (12)

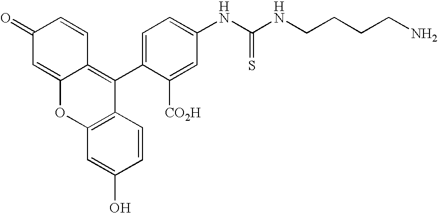

Prepared from 1,4-diaminobutane trityl polystyrene resin.

HPLC (420 nm): 7.27 min

Fluorescein Labeled ‘PAMAM’ Dendrimer (13)

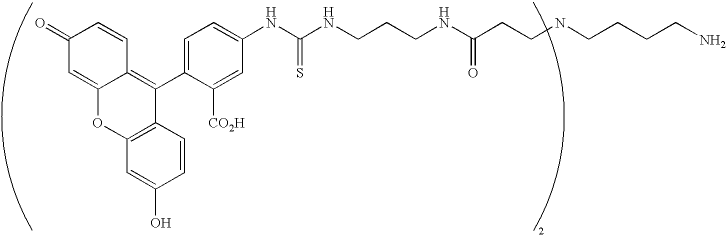

Prepared from ‘PAMAM’ dendrimer resin 4.

Yield: 29.0 mg (25.8 μmol, 81%).

m/z (ES+): [M+H]⁺=1123.6

HPLC (440 nm): 7.73 min

Fluorescein Labeled Tris Dendrimer (14)

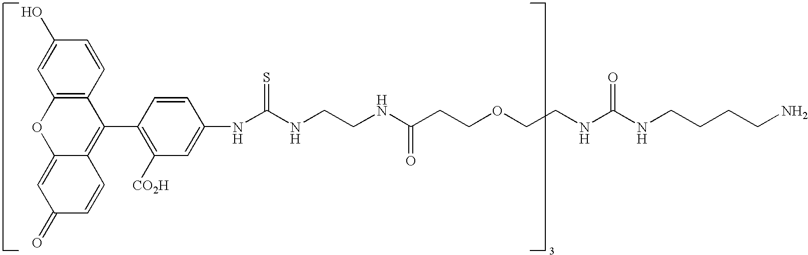

Prepared from the tris dendrimer resin 9.

Yield: 17.4 mg (9.97 μmol, 8%).

m/z (ES−): [M−H]⁻=1743, [M−2H]²⁻=871, [M−3H]³⁻=580

HPLC (440 nm): 8.28 min

Fluorescein Labeled Hybrid Dendrimer (15)

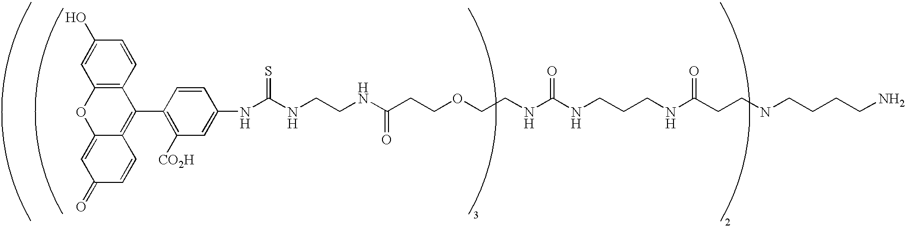

Prepared from the hybrid dendrimer resin 11.

Yield: 18.7 mg (0.51 μmol)

m/z (ES−): [M−2H]²⁻=1827, [M−3H]³⁻=1218, [M−4H]⁴⁻=913, [M−5H]⁵⁻=730, [M−6H]⁶⁻=609

HPLC (440 nm): 8.60 min

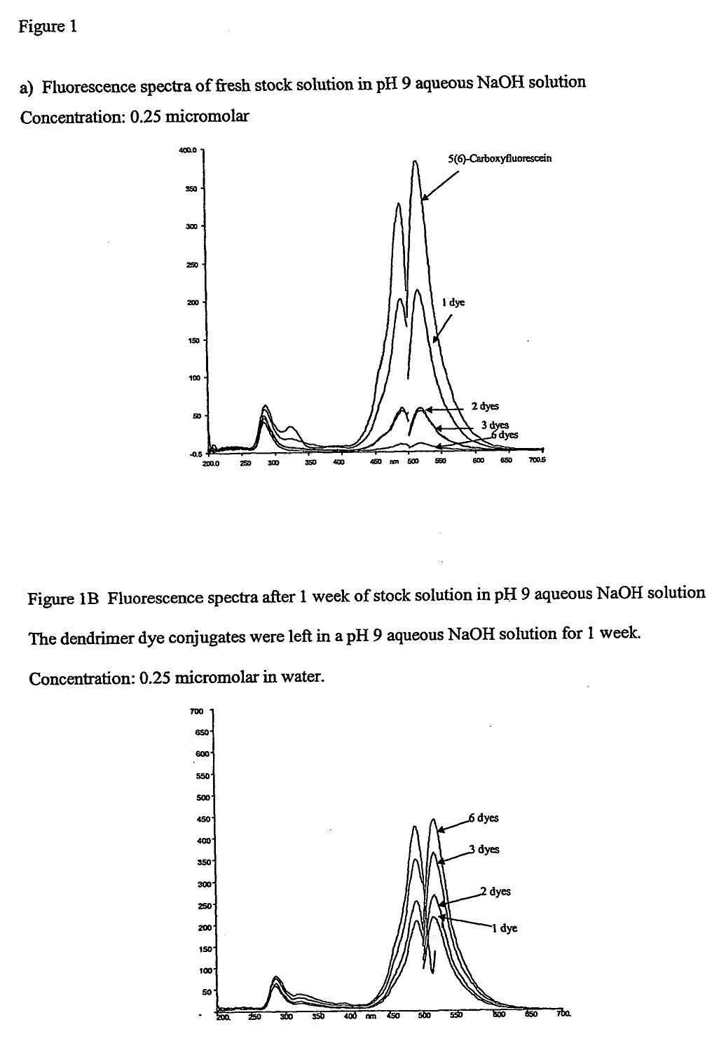

The dendrimer dye molecules 13, 14 and 15 and compound 12 were placed in pH9 aqueous NaOH and the fluorescence measured at time zero and after 7 days. The results are shown in FIG. 1 and demonstrate the NaOH treatment resulted in the cleavage of the amide bond releasing the dye from the dendrimer dye molecule.

### EXAMPLE 3

### Enzymatic Cleavage of Dendrimer Dye Molecule

a) Cleavage with Chymotrypsin

Analytical HPLC was carried out on a Hewlett Packard 1100 Chemstation with a Phenomenex Prodigy C₁₈ 150×4.6 mm column (analytical flow 0.5 ml/min). The solvent gradient ran from water with 0.1% TFA to MeCN with 0.042% TFA over 20 minutes. Semi-preparative HPLC was performed on a HP1100 system equipped with a Phenomenex Prodigy C₁₈ reverse phase column (250×10.0 mm, flow rate 2.5 ml/min) eluting with water with 0.1% TFA to MeCN with 0.042% TFA over 20 minutes followed by 5 minutes in MeCN with 0.042% TPA and then a further 5 minutes to return to water containing 0.1% TFA. Electrospray mass spectra were recorded on a VG Platform Quadrupole Electrospray Ionisation mass spectrometer. MALDI spectra were recorded on a Micromass Tofspec 2E reflection matrix assisted laser desorption ionisation time of flight (MALDI-TOF) mass spectrometer.

FITC-Ala-Lys(Boc)-Leu-Ala-diaminobutane peptide (16)

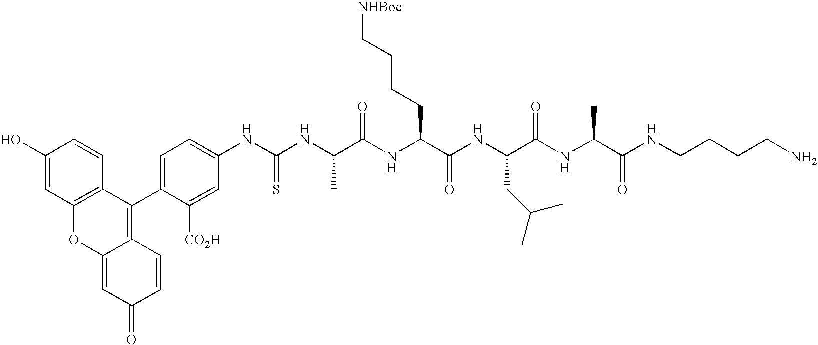

Starting from 1,4-diaminobutane trityl PS resin (0.2 g, 0.3 mmol, loading: 1.5 mmol/g). The peptide was prepared using standard Fmoc peptide chemistry with 4 equivalents each of DIC, HOBt and the amino acid in DCM with enough DMF to dissolve the amino acid. Each coupling was run overnight and repeated twice. After the two initial FmocAlaOH couplings the unreacted sites were capped with acetic anhydride (10 eq.) and pyridine (cat.) in DCM overnight. A small amount of resin was cleaved with 50% TFA, 3% TIS in DCM after each step to monitor the coupling by HPLC and MS. The resin was swollen in DCM and then shaken in 20% piperidine in DMF for 2×10 minutes. The resin was then washed with DMF (3×), DCM (3×), MeOH (3×) and Et₂O (3×) and finally swollen in DCM. To the resin was added a solution of fluorescein isothiocyanate isomer 1 (2 eq.) and triethylamine (2 eq.) in DMF and the mixture spun on the wheel overnight. The resin was washed with DMF (3×), DCM (3×), MeOH (3×) and Et₂O (3×). The resin (0.178 g) was swollen in DCM and a solution of 30% hexafluoroisopropanol in DCM (2 ml) was added and the mixture stood for 3 hours. The solution was drained and the resin washed with DCM and MeOH (2×). The solvent was removed in vacuo to afford crude 16 (0.217 g) as an orange solid. Precipitation from Et₂O afforded 0.0881 g. Purification of 28.3 mg by semiprep. HPLC followed by lyophilization afforded 16 as a yellow solid (19.6 mg, 54% from 1,4-diaminobutane trityl resin).

HPLC (440 nm): 8.3 mins.

MS (ES+): 961 (MH⁺).

FITC-Ala-Lys(Boc)-Leu-Ala ‘PAMAM’ dendrimer peptide (17)

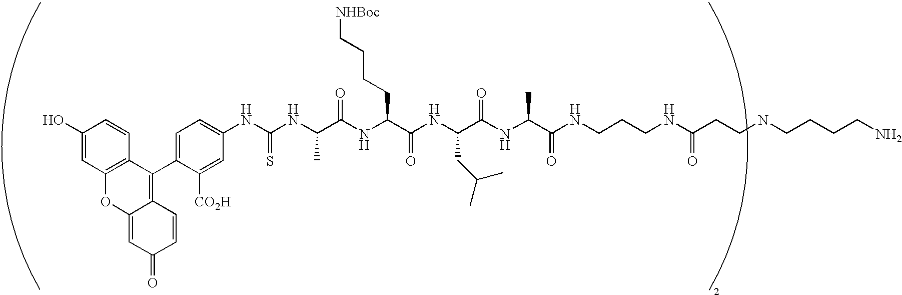

Starting from TentaGel gen. [1.0] PAMAM dendrimer resin 4 (0.3 g, 0.13 mmol, theor. loading NH₂: 0.42 mmol/g) the peptide was prepared using the same method as described for the synthesis of 16. After cleavage (0.2562 g of resin), ether precipitation, semiprep. HPLC and lyophilization 17 (7.4 mg, 9% from TGT alcohol resin) was obtained as a yellow solid.

HPLC (440 nm): 8.8 mins.

MS (MALDI): 2091 (MH⁺).

FITC-Ala-Lys(Boc)-Leu-Ala tris dendrimer (18)

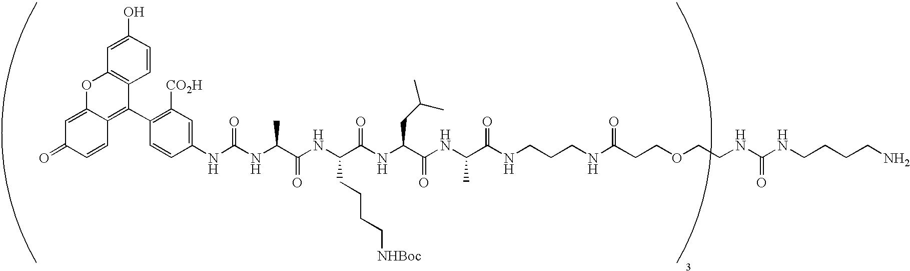

Starting from Gen. [1.0] tris dendrimer resin 9 (0.3 g, 0.26 mmol, theor. loading NH₂: 0.84 mmol/g). Peptide dendrimer 18 was prepared according to the method described for the preparation of 16. After cleavage (0.077 g of resin), ether precipitation, semiprep. HPLC and lyophilization, 18 (7.4 mg, 19% from 1,4-diaminobutane trityl resin) was obtained as a yellow solid.

HPLC (440 nm): 9.5 mins.

MS (MALDI): 3240 (M⁺).

Cleavage by Chymotrypsin Enzyme Experiments

The reaction mixture was made up as follows:

50 mM pH 8.1 HEPES buffer solution

10 mM CaCl₂ solution

0.1M NaCl solution

10 μM peptide solution

0.3 μM chymotrypsin solution (α-chymotryspin, bovine pancreas—Calbiochem)

An Eppendorf™ tube containing the reaction mixture was suspended in a water bath at 25° C. Samples for fluorescence measurements were prepared by taking 3 μl of the reaction mixture and adding it to 3000 μl of a pH 9 buffer solution (sodium tetraborate buffer). The control experiments were run in an identical manner simultaneously to the corresponding enzyme experiment but with water added in place of the chymotrypsin solution. Solutions were made up with water and HEPES buffer solution and then this solution was added to the reaction mixture in place of the separate peptide and buffer solutions described above.

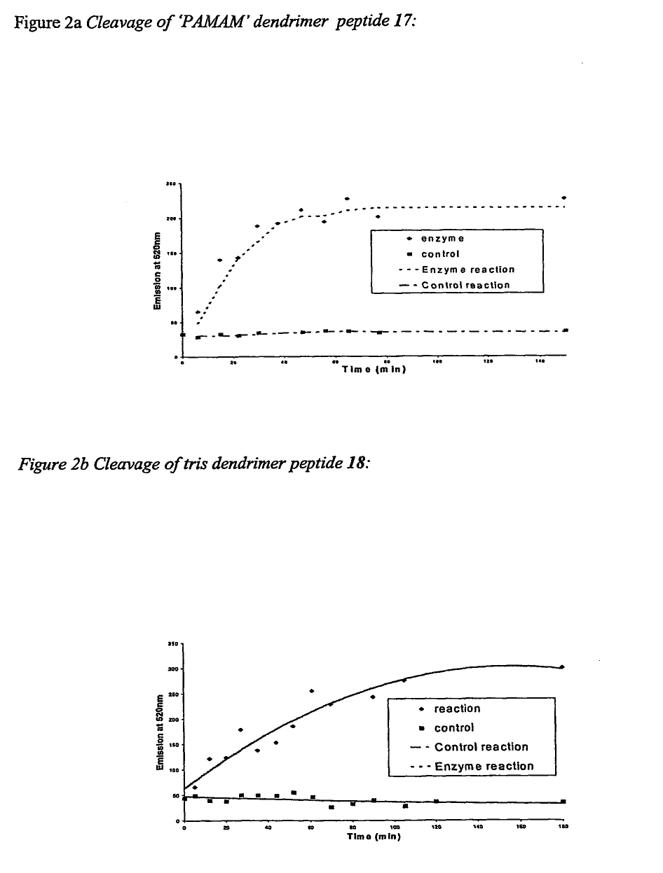

The results are shown in FIG. 2 and demonstrate the increase in fluorescence obtained by enzyme cleavage of compounds 17 and 18. The cleavage for 16 is not shown as only a single dye is present and no dye-dye quenching is possible.

Cleavage of Single Peptide 16:

This was performed as above and the dye fragment obtained was verified by mass spectrometry.

MS (ES+): 820 (MH⁺).

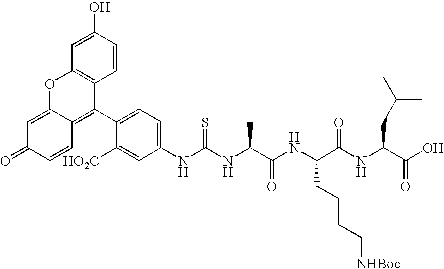

b) Endoproteinase Asp-N

Fmoc-Tyr-Val-Ala-Asp-Ala-Pro-Val-Lys-diaminobutane peptide resin (19)

Starting from 1,4-diaminobutane trityl PS resin (0.22 g, 0.33 mmol, loading: 1.5 mmol/g). The peptide was prepared using standard Fmoc chemistry using 4 equivalents of amino acid, HOBt and DIC in DCM with enough DMF to dissolve (0.2-0.3M). Each coupling was run for approximately 3 hours and the coupling was monitored by ninhydrin test with the exception of the coupling onto the proline residue which was monitored by chloroanil test. The initial coupling was repeated 3 times and was followed by a capping step with acetic anhydride and catalytic pyridine in DCM overnight After each coupling a small amount of resin was cleaved with 50% TFA, 3% TIS in DCM and analyzed by HPLC and ES-MS.

HPLC (254 nm): 6.9 mins.

ES-MS: 1154(MH⁺).

SO₃Cy5-Tyr-Val-Ala-Asp-Ala-Pro-Val-Lys-diaminobutane peptide (20)

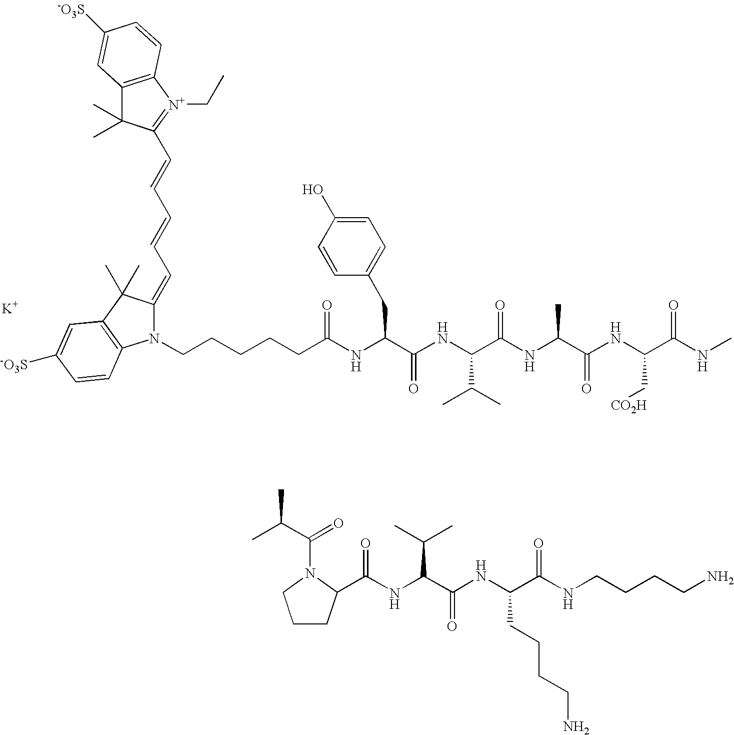

The resin 19 (7.1 mg, 3.6 μmol, max theor. loading: 0.51 mmol/g) was swollen in DCM and then treated with 20% piperadine in DMF (2×10 mins). The resin was washed with DMF×3, DCM×3, MeOH×3 and Et₂O×3, then reswollen in DCM. To the swollen resin was added sulfonated Cy5 dye NHS ester (4.1 mg, 5.2 μmol) and triethylamine (0.7 μl, 5 μmol) in DMF (0.5 ml) and the reaction mixture was spun over the weekend. The resin was washed with DMF×3, DCM×3, MeOH×3 and Et₂O×3, swelled in DCM and then treated with 50% TFA, 3% TIS in DCM (0.5 ml) for 45 minutes. The cleavage cocktail was then poured into ice-cold ether and centrifuged. The solvent was then decanted off and the precipitate was washed with ice-cold ether, centrifuged, the solvent decanted off and the precipitate dried in vacuo. Purification by semi-prep HPLC and freeze drying (the peptide did not lyophilize) afforded 20 as a blue solid (4.3 mg, 74% yield from 1,4-diaminobutane trityl resin).

HPLC (600 nm): 6.8 mins.

MALDI: 1571 (MH⁺)

Fmoc-Tyr-Val-Ala-Asp-Ala-Pro-Val-Lys-tris dendrimer peptide (21)

Starting from the tris dendrimer resin 9 (0.29 g, 0.08 mmol, theor. loading: 0.28 mmol/g, theor. loading NH₂: 0.84 mmol/g). The peptide was prepared using standard Fmoc peptide synthesis with 4 equivalents (with respect to the number of moles NH₂) of DIC, HOBt and amino acid in DCM and DMF (0.2-0.3M). Each coupling was run for 3-5 hours and was repeated twice. After each step a small amount of resin was cleaved by 50% TFA, 3% TIS in DCM and analyzed by HPLC and ES-MS.

HPLC (254 nm): 8.6 mins.

ES-MS: 1273 (M+3H)/3, 955 (M+4H)/4.

SO₃Cy5-Tyr-Val-Ala-Asp-Ala-Pro-Val-Lys-tris dendrimer peptide (22)

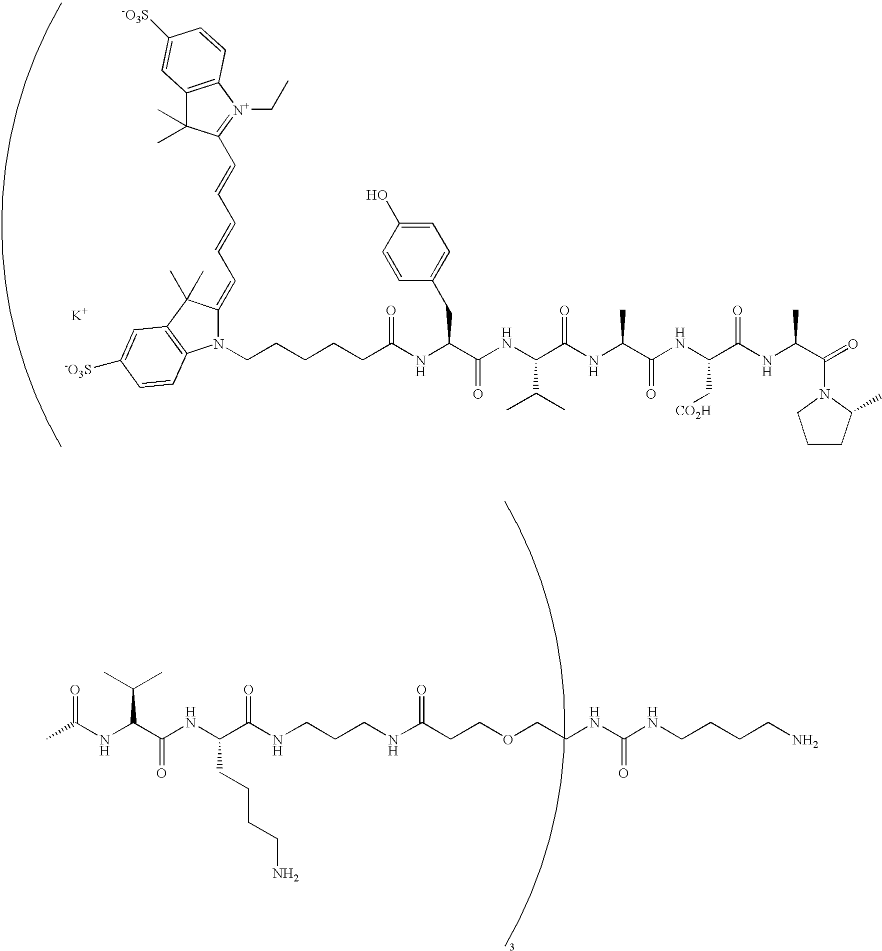

Prepared from the resin 21 (14.2 mg, 1.9 μmol, 5.8 μmol NH₂, max loading: 0.14 mmol/g, max. loading NH₂: 0.41 mmol/g) according to the procedure for the preparation of 20 with the sulfonated Cy5 dye NHS ester (7.2 mg, 9.1 μmol) and triethylamine (1.3 μl, 9.3 μmol). Purification afforded 22 as a blue solid (2.0 mg, 20% yield from 1,4-diaminobutane resin).

HPLC (600 nm): 7.3 mins.

MALDI: 5066.

Asp-N Enzyme Experimental

Endoproteinase Asp-N was purchased from Sigma. The enzyme (2 μg) was reconstituted in 50 μl of water. The assays were performed with a 1:50 enzyme:substrate by weight ratio.

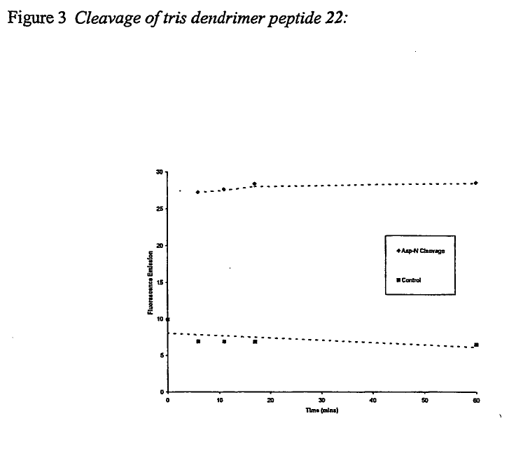

Thus the assay contained 2 μl of enzyme solution and 10 μM peptide solution in phosphate buffer (100 μM, pH 8.0) containing 4 μg of peptide. The assay was incubated in a Eppendorf™ tube at 37° C. Samples for fluorescence were made by taking 3 μl of the assay solution and adding it to 3000 μl of a pH 9 buffer solution (sodium tetraborate buffer). Control experiments were run simultaneously with the assay under identical conditions but with 2 μl of water in the place of the enzyme solution. The results shown in FIG. 3 demonstrate enhancement of fluorescent signal upon enzyme cleavage. HPLC was conducted to confirm cleavage.

1. A dendrimer dye molecule or poly-branched molecule linked dye structure comprising at least one cleaveable linkage within said dye molecule or structure such that when the linkage is cleaved a change in at least one optical property of the dye occurs.

2. The dendrimer dye molecule or poly-branched molecule linked dye of claim 1, wherein the change of optical property of the dye is an increase in fluorescence.

3. The dendrimer dye molecule or poly-branched molecule of claim 2, wherein the increase in fluorescence is at least 1.2 fold.

4. The dendrimer dye molecule or poly-branched molecule linked dye of claim 1, not requiring a quenching agent of a different molecular species to the fluorescent molecule.

5. (cancelled)

6. The dendrimer dye molecule or poly-branched molecule linked dye of claim 1, wherein the cleavable linkage is cleavable by an enzyme.

7. The dendrimer dye molecule or poly-branched molecule linked dye of claim 6, wherein the enzyme is a protease.

8. The dendrimer dye molecule or poly-branched molecule linked dye of claim 7, wherein the protease is chymotrypsin or proteinase Asp-N.

9. The dendrimer dye molecule or poly-branched molecule linked dye of claim 1, wherein the cleavable linkage is cleavable by a chemical reaction.

10. The dendrimer dye molecule or poly-branched molecule linked dye of claim 1, which has been reacted with a biomolecule or solid support to form a conjugate.

11. A method of investigating the properties of a biological molecule comprising the steps of
a) performing a reaction containing the biological molecule of interests at least some of which has been labelled with the dendrimer dye molecule or poly-branched molecule linked dye tof claim 1;
b) treating the product of step a) if necessary with an agent capable of cleaving the cleavable linkage; and
c) measuring the change in optical property.

12. The method of claim 11, wherein the change in optical property is an increase in fluorescence.

13. The method of claim 12, wherein the increase in fluorescent signal is at least 1.2 fold.


SEQUENCE LISTING (2 sequences)

SEQ ID NO: 1 - protein, 4 aa, ARTIFICIAL SEQUENCE
  SYNTHETIC PEPTIDE
AKLA

SEQ ID NO: 2 - protein, 8 aa, ARTIFICIAL SEQUENCE
  SYNTHETIC PEPTIDE
YVADAPVK